(19) United States
(12) Patent Application Publication
(10) Pub. No.: US 2015/0211890 A1
(43) Pub. Date: Jul. 30, 2015

(54) Sensor Arrangement for Detecting Angles of Rotation on a Rotated Component

(71) Applicant: Robert Bosch GmbH, Stuttgart (DE)

(72) Inventors: Eduard Maiterth, Heilbronn (DE); Mathias Kimmerle, Steinheim (DE); Klaus Walter, Bietigheim-Bissingen (DE); Juergen Kissner, Oppenweiler (DE); Joerg Siedentopf, Untergruppenbach (DE)

(21) Appl. No.: 14/422,711

(22) PCT Filed: Aug. 19, 2013
(86) PCT No.: PCT/EP2013/067225

§ 371 Date: Feb. 20, 2015

(30) Foreign Application Priority Data
Aug. 22, 2012 (DE) 10 2012 214 916.3

(51) Int. Cl. G01D 5/14

(52) U.S. Cl. CPC G01D 5/14

(57) ABSTRACT

A sensor arrangement for detecting angles of rotation on a rotated component, comprising a measurement value transmitter having at least one permanent magnet with magnetic north and south pole regions and which is arranged at a specified first radial distance to the rotational axis of the rotated component, and comprising a measurement value sensor, which comprises at least one sensor element for detecting at least one magnetic variable, said sensor element being arranged at a specified second radial distance to the rotational axis of the rotated component. A movement of the rotated component causes a change of the at least one magnetic variable, which can be evaluated in order to ascertain the rotational angle. The permanent magnet is polarized in a circumferential direction along a circular arc about the rotational axis or tangentially thereto, and a magnetic vector is generated on a detection plane perpendicular to the magnet surface.

### PRIOR ART

The invention proceeds from a sensor arrangement for detecting angles of rotation on a rotated component according to the category of the independent patent claim 1.

In order to detect the angle of a rotating shaft, it is known from the prior art to detect the rotational movement of a magnet centrically on the shaft. For this purpose, the rotation of the magnetic vector about the rotational axis is detected by using appropriately sensitive magnetic sensors such as, for example, AMR and/or GMR sensors, Hall sensors, Hall sensors with integrated magnetic field concentrators etc. The detection of the rotating magnetic vector is essential for the sensor element being used. In the case of a magnet which is designed, for example, as a round magnet and rotates in front of the sensor element, the magnetic vector also rotates. This rotational movement is detected by a sensor element located therebefore which is part of an ASIC (Application-Specific Integrated Circuit) and detects the magnetic vector parallel to the magnet surface. In the case of a two-dimensional or three-dimensional Hall sensor, this is performed by an indirect angular detection via an arc-tangent function of the directed magnetic flux densities. Such a Hall sensor can unambiguously detect the angular position of the round magnet over 360°. AMR sensors permit a direct angular detection and in principle directly detect the angle of the magnetic vector. Devices for detecting angle and/or distance can be used in vehicles in various operating devices for vehicle braking systems, for beam width control and for detecting the angular position of shafts, also, in particular, for a driver's braking demand detection at the brake pedal, and/or for a driver's accelerating demand detection at the gas pedal.

The measuring elements are disposed on a defined angular range. Thus, for example, an AMR sensor can typically be used to detect angular rotation of the magnetic vector unambiguously by 180°. Two-dimensional or three-dimensional Hall sensors, by contrast, detect an angular rotation of the magnetic vector by 360° by means of integrated magnetic field concentrators or via Hall elements in all three planes. The resulting accuracies are optimally adapted to said angle ranges. When angles which are substantially smaller than the measuring range of the sensor element are being detected, there is a reduction in the resulting resolution and/or in the accuracy of the output signal referred to the measuring range. In the case of a sensor that identifies magnetic angles and has a measuring range of 360°, there is a reduction by a factor of 10 in percentage accuracy referred to the measuring range when the total measuring range in the application is only 36°.

DE 10 2009 055 104 A1 describes a magnetic field sensor arrangement for distance detection at components moving by translation. In the magnetic field sensor arrangement described, spatial components of the magnetic field of a magnet system on the moved component change their direction over the distance to be detected such that their position can be correspondingly detected relative to a fixed sensor. Located on the component, which moves linearly and in a further degree of freedom, is at least one magnet which serves as a constituent of the magnet system to which at least one fixed sensor situated opposite and sensitive to magnetic fields is assigned at a prescribed distance.

DE 10 2007 024 867 A1 describes a measuring device for contactless detection of an angle of rotation. The described measuring device comprises a first body on which a magnet is arranged at a radial distance from a rotational axis, and a second body with an element sensitive to magnetic fields for generating a measuring signal. Here, in the case of a relative movement the element sensitive to magnetic fields and the magnet are arranged tangentially relative to a circular track of the relative movement between the first and second bodies, the magnet being radially magnetized or polarized in a plane arranged perpendicular to the radial direction relative to the rotational axis.

DE 10 2008 020 153 A1 describes an angle detection device. The device described comprises a rotating element with at least one magnetic north pole region and at least one magnetic south pole region which are arranged alternately around a center of rotation, a magnetic field detection section with a magnetic disk and detecting elements which detect magnitudes of magnetic components in a direction perpendicular to the magnetic disk, and an arithmetic logic unit which determines an angle of rotation of the rotating element. The magnetic field detection section is arranged such that the magnetic disk is aligned perpendicular to a first direction in which the magnetic field strength is maximum, the magnetic field detection section detecting the magnitudes of the magnetic components in the first direction and in a second direction which corresponds to a direction in which the magnetic north and south pole regions are arranged circumferentially.

### DISCLOSURE OF THE INVENTION

The sensor arrangement according to the invention for detecting angles of rotation on a rotated component which comprises the features of the independent patent claim 1 has, by contrast, the advantage that, instead of an angular measurement at the center of the rotational movement, a magnetic vector measurement is taken of a measured value transmitter, moved on a rotational path, with at least one multipole, or of a measured value sensor with at least one sensor element. In this case, it is no longer the magnetic vector parallel to the magnet surface that is detected—instead, it is the magnetic vector in the plane perpendicular to the magnet. When the measured value transmitter or measured value sensor passes by, said magnetic vector rotates by an angle in the region of, for example, 150° to 240°, depending on the magnetic air gap between the measured value transmitter and the measured value sensor when passing by. Embodiments of the sensor arrangement according to the invention for detecting angles of rotation on a rotating component are suitable, in particular, for detecting angles of rotation in a measuring range from 5° to 95°.

The core of the invention resides in replacing an angular measurement by a distance measurement on a rotational path with a prescribed radius. The detected magnetic vector is therefore in a direct and defined relationship with the distance on the circular track, and thus also with the angle of the angular segment swept over. The detection of the magnetic vector in the measured value sensor is performed directly by sensor elements which are sensitive in this regard such as, for example, AMR sensors, or indirectly via the evaluation of directed magnetic flux densities in the detection plane by means of an arc-tangent function. By adapting the radius and/or the length of the at least one multipole, the angular range to be measured can be optimally tuned to the measuring range of the sensor element. The position of the measured value sensor relative to the at least one measured value transmitter is arranged in such a way that the magnetic vector which lies in a plane perpendicular to the multipole is always detected, the individual permanent magnets of the at least one multipole being magnetized or polarized in the circumferential direction, and the sensor element being aligned with the at least one multipole in such a way that said magnetic vector component can be detected directly or indirectly by the sensor element. In the case of indirectly measuring sensors, the position of the sensor element is to be represented such that it is possible to detect that plane of the magnetic vector which is to be detected. In the case of directly measuring sensors, it is likewise necessary to consider the correct alignment of the sensitive plane of the measuring element with that plane of the magnetic vector which is to be measured.

Embodiments of the present invention advantageously enable an optimum adaptation of the sensor arrangement according to the invention to geometric conditions in conjunction with optimum utilization of the resolution of the prescribed sensor element which can, for example, be designed as a Hall sensor, AMR sensor, GMR sensor etc. The sensor element can advantageously be selected and dimensioned with regard to the radius of the rotational path, the radial distance between the measured value transmitter and the measured value sensor, and/or the dimensions of the at least one multipole, and/or the number of multipoles, and/or the dimensions of the at least one permanent magnet, and/or the number of the permanent magnets of the at least one multipole, such that it is possible to achieve an optimum resolution over the angular range, that is to say as large as possible a change in the magnetic field orientation over the measured distance and/or measured angle.

Embodiments of the present invention enable a flexible sensor arrangement for detecting angles of rotation on a rotated component which can be used in different installation spaces of different applications with different measured angles in conjunction with unchanged measured value sensors or, if required, merely by adapted programming of the measured value sensor.

Embodiments of the present invention make available a sensor arrangement for detecting angles of rotation on a rotated component, having a measured value transmitter which comprises at least one permanent magnet with a magnetic north pole region and a magnetic south pole region, and which is arranged with a prescribed radial first distance from the rotational axis of the rotated component, and a measured value sensor which, for the purpose of detecting at least one magnetic variable, comprises at least one sensor element which is arranged with a prescribed second radial distance from the rotational axis of the rotated component. Here, a movement of the rotated component effects a variation in the at least one magnetic variable which can be evaluated in order to determine the angle of rotation, the at least one permanent magnet being polarized along a circular arc, prescribed via the first radial distance, about the rotational axis or tangential thereto, and generating a magnetic vector in a detection plane perpendicular to the magnet surface. According to the invention the measured value transmitter has at least one multipole which comprises at least two permanent magnets which are arranged such that the mutually facing ends of directly adjacent permanent magnets of the multipole have the same magnetic polarization. When use is made of two permanent magnets for the multipole, the arrangement according to the invention can advantageously be used to generate an unambiguous measuring signal over the entire measuring range of the multipole.

Advantageous improvements in the sensor arrangement, specified in the independent patent claim 1, for detecting angles of rotation on a rotated component are possible by means of the measures and developments set forth in the dependent claims.

In an advantageous refinement of the sensor arrangement according to the invention, the at least one sensor element can directly detect an angle of the magnetic vector, the detected angle of the magnetic vector representing the angle of rotation of the rotated component. Alternatively, the at least one sensor element can detect directed magnetic flux densities and can convert them into an angle of rotation for the rotated component via an arc-tangent function.

In a further advantageous refinement of the sensor arrangement according to the invention, the measured value transmitter can be coupled to the rotated component, and the measured value sensor can be fixedly fastened with a prescribed radial distance from the circular track of the measured value transmitter. Alternatively, the measured value sensor can be coupled to the rotated component, and the measured value transmitter can be fixedly fastened with a prescribed radial distance from the circular track of the measured value sensor.

It is particularly advantageous that the prescribed first and/or second radial distance of the measured value transmitter and/or of the measured value sensor from the rotational axis of the rotated component, and/or the prescribed radial distance between the measured value transmitter and the measured value sensor, and/or the dimensions of the at least one multipole, and/or the number of the multipoles, and/or the dimensions of the at least one permanent magnet, and/or the number of the permanent magnets of the at least one multipole, and/or the dimensions of the at least one sensor element, and/or the number of the sensor elements of the measured value sensor can be adapted to an installation space and a measured angle range. The arrangement of the measured value transmitter and/or of the measured value sensor are preferably adapted to the installation space and the measured angle range such that a maximum change in the angle of the magnetic vector occurs over the measured angle range.

In a further advantageous refinement of the sensor arrangement according to the invention, the at least one sensor element of the measured value sensor can, for example, be designed as an AMR sensor and/or GMR sensor and/or Hall sensor.

In a further advantageous refinement of the sensor arrangement according to the invention, the at least two permanent magnets of the at least one multipole of the measured value transmitter can be designed as simple bar magnets with a round or rectangular cross section and/or as bar magnets with a round or rectangular cross section and with a single-ended and/or double-ended rounded portion. The rounded portion can have a curvature which corresponds to the prescribed circular arc of the rotational path of the measured value transmitter or of the measured value sensor.

In a further advantageous refinement of the sensor arrangement according to the invention, the at least two permanent magnets of the at least one multipole of the measured value transmitter can be combined to form a tripole with three magnetic poles which has identical magnetic poles at its ends. The resultant tripole is, for example, a north pole/south pole/north pole or a south pole/north pole/south pole sequence of the magnetic poles.

The rotating component can correspond, for example, to a pedal such as, for example, a brake pedal or a gas pedal, or to a steering column.

Exemplary embodiments of the invention are illustrated in the drawings and explained in more detail in the following description. In the drawings, identical reference symbols denote components and/or elements which execute the same or similar functions.

### BRIEF DESCRIPTION OF THE DRAWINGS

FIG. 1 shows a schematic perspective plan view of an exemplary embodiment of a sensor arrangement according to the invention for detecting angles of rotation on a rotated component which is used for a driver's braking demand recognition.

FIG. 2 shows a schematic perspective sectional illustration of the exemplary embodiment of the sensor arrangement according to the invention for detecting angles of rotation on a rotated component from FIG. 1.

FIG. 3 shows a schematic illustration of magnetic field lines of a multipole for the sensor arrangement according to the invention for detecting angles of rotation on a rotated component from FIG. 1 or 2.

FIG. 4 shows a schematic perspective illustration of a first exemplary embodiment of a multipole for the sensor arrangement according to the invention for detecting angles of rotation on a rotated component from FIG. 1 or 2.

FIGS. 5 to 9 show schematic perspective illustrations of various exemplary embodiments of permanent magnets for forming multipoles for the sensor arrangement according to the invention for detecting angles of rotation on a rotated component from FIG. 1 or 2.

FIG. 10 shows a schematic illustration of a first exemplary arrangement for a sensor arrangement according to the invention for detecting angles of rotation on a rotated component having a moving measured value transmitter with a multipole which comprises two permanent magnets, and a stationary measured value sensor.

FIG. 11 shows a schematic illustration of a second exemplary arrangement for a sensor arrangement according to the invention for detecting angles of rotation on a rotated component having a stationary measured value transmitter with a multipole which comprises two permanent magnets, and a moving measured value sensor.

FIG. 12 shows a schematic illustration of the relationship between radius, circular track and angular measuring range of the sensor arrangement according to the invention for detecting angles of rotation on a rotated component.

FIGS. 13 and 14 show possible relative positions of a stationary measured value sensor relative to a measured value transmitter moving on a circular track.

FIGS. 15 and 16 show possible relative positions of a stationary measured value transmitter relative to a measured value sensor moving on a circular track.

FIG. 17 shows a schematic illustration of a third exemplary arrangement for a sensor arrangement according to the invention for detecting angles of rotation on a rotated component having a moving measured value transmitter with a multipole, which comprises four permanent magnets, and a stationary measured value sensor.

### EMBODIMENTS OF THE INVENTION

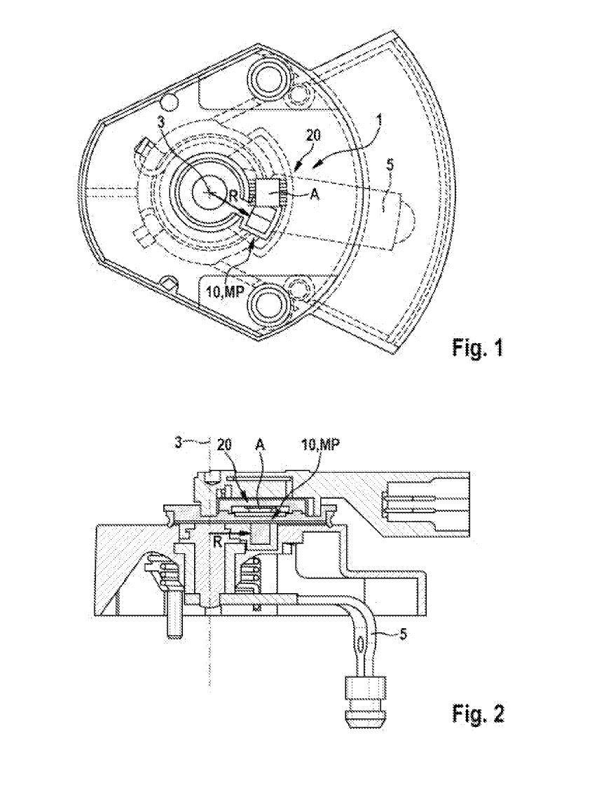

As is evident from FIGS. 1 to 17, the illustrated exemplary embodiments comprise a sensor arrangement 1, 1a, 1′ according to the invention for detecting angles of rotation α, α1, α2 on a rotated component 5 for a vehicle, a measured value transmitter 10, 10a, which comprises at least one permanent magnet M1, M2, M3, M4 with a magnetic north pole region N and a magnetic south pole region S and which is arranged with a prescribed radial first distance R, R1, R2, R−l, R+l relative to the rotational axis 3 of the rotated component 5, and a measured value sensor 20, which comprises at least one sensor element A, A′, A1, A2, for detecting at least one magnetic variable, which is arranged with a prescribed second radial distance R, R−l, R+l from the rotational axis 3 of the rotated component 5. Here, a movement of the rotated component effects a variation in the at least one magnetic variable which can be evaluated in order to determine the angle of rotation α, α1, α2, the at least one permanent magnet M1, M2, M3, M4 being polarized along a circular arc B, B1, B2, prescribed via the first radial distance R, R1, R2, R−l, R+l, about the rotational axis or tangential thereto, and generating a magnetic vector in a detection plane perpendicular to the magnet surface.

According to the invention, the measured value transmitter 10, 10a comprises at least one multipole MP, MPa, MP′, MP1, MP2 which comprises at least two permanent magnets M1, M2, M3, M4 which are arranged such that the mutually facing ends of directly adjacent permanent magnets M1, M2, M3, M4 of the multipole MP, MPa, MP′, MP1, MP2 have the same magnetic polarization S, N.

As is evident from FIGS. 1 to 4, the illustrated exemplary embodiment illustrates a use of the sensor arrangement according to the invention for detecting the angle of rotation of a rotated component 5 which is coupled to a pedal in order to detect a driver's demand at the brake pedal or gas pedal. As is further evident from FIGS. 1 and 2, a shaft 3 is rotated via a lever 5 by a pedal (not illustrated). Connected to the shaft 3 is the measured value transmitter 10 which comprises a multipole MP which moves in accordance with the shaft rotation (for example 30°) on a circular track with a prescribed radial distance R from the shaft axis 3. Located via the multipole MP at a defined distance which represents a magnetic air gap is the measured value sensor 20 which is preferably designed as an ASIC (Application-Specific Integrated Circuit) with at least one sensor element A. Said sensor element A detects the magnetic vector which changes in the plane perpendicular to the multipole MP during the rotational movement. The rotation of the multipole MP in said plane has a defined relationship with the path along the circular segment B which, in turn, is in a relationship, defined by equation (1), with the angle of rotation a of the shaft 3.

$$B = \frac{α}{360 °} * 2 π * R \qquad ( 1 )$$

The at least one sensor element A thus supplies a signal to a downstream evaluation circuit of the ASIC, which can be converted into the absolute angle of rotation which the lever 5 experiences.

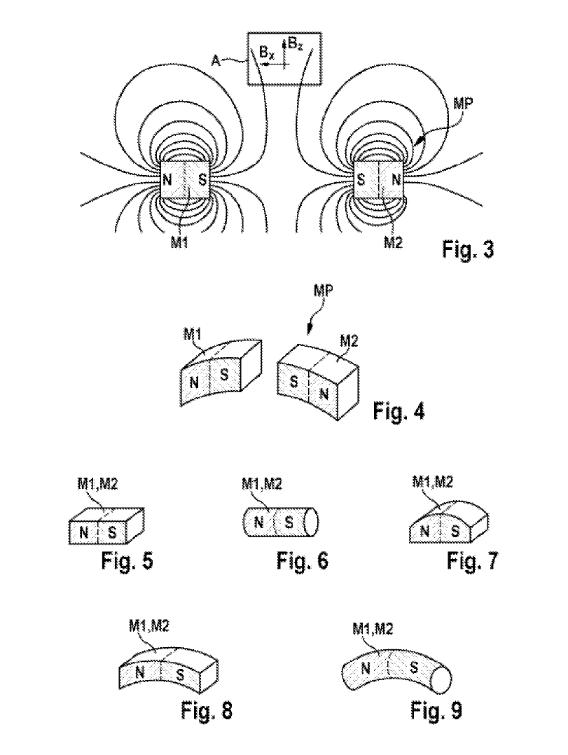

As is further evident from FIGS. 3 and 4, the measured value transmitter 10 in the exemplary embodiment illustrated comprises a multipole MP with two individual permanent magnets M1, M2, which are polarized in the direction of the circular track, that is to say tangential relative to the circular track, the two permanent magnets M1, M2 being arranged such that the mutually facing ends of the adjacent permanent magnets M1, M2 of the multipole MP have the same magnetic polarization. In the exemplary embodiment illustrated, the magnetic south poles S of the two adjacent permanent magnets M1, M2 face one another. Consequently, the multipole MP advantageously generates over the total measuring range an unambiguous measuring signal in the at least one sensor element A of the measured value sensor 20 such that a corresponding angle of rotation of the shaft 3 can be determined without ambiguities.

As is further evident from FIGS. 5 to 9, the individual permanent magnets M1, M2 of the multipole MP can have various embodiments. Thus, by way of example FIG. 5 shows an embodiment in which the permanent magnet M1, M2 illustrated is designed as a simple bar magnet with a rectangular cross section. FIG. 6 shows an embodiment in which the permanent magnet M1, M2 illustrated is designed as a simple bar magnet with a round cross section. FIG. 7 shows an embodiment in which the permanent magnet M1, M2 illustrated is designed as a bar magnet with a rectangular cross section and a single-ended rounded portion. In an embodiment that is not illustrated, the permanent magnet M1, M2 is designed as a bar magnet with a round cross section and a single-ended rounded portion. FIG. 8 shows an embodiment in which the permanent magnet M1, M2 illustrated is designed as a bar magnet with a rectangular cross section and a double-ended rounded portion. FIG. 9 shows an embodiment in which the permanent magnet M1, M2 illustrated is designed as a bar magnet with a round cross section and a double-ended rounded portion. In the exemplary embodiments, the single-ended or double-ended rounded portion has a curvature which corresponds to the prescribed circular arc B, B1, B2 of the rotational path of the measured value transmitter 10 or of the measured value sensor 20.

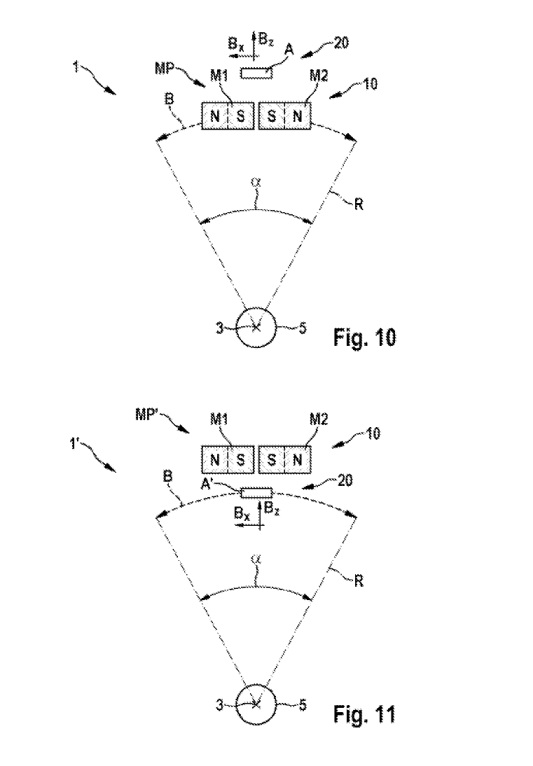

FIG. 10 shows a first exemplary embodiment of the sensor arrangement according to the invention for detecting angles of rotation a on a rotated component 5, in the case of which the measured value transmitter is coupled to the rotated component 5, and the measured value sensor 20, which comprises at least one sensor element A, is fixedly fastened. As already set forth above, the measured value transmitter 10 comprises the multipole MP with two permanent magnets M1, M2, which are located with a radial distance R from the rotational axis 3 on a rotational path, and which move on a circular track in the event of a rotation relative to the magnetically-sensitive sensor element A of the measured value sensor 20. The permanent magnets M1, M2 are polarized in the circumferential direction or tangential thereto and generate a magnetic vector in a plane perpendicular to the magnet surface which is detected by the sensor element A upon passing by, the two permanent magnets M1, M2 being arranged such that the mutually facing ends of the permanent magnets M1, M2 have the same magnetic polarization. In the exemplary embodiment illustrated, the magnetic south poles S of the two adjacent permanent magnets M1, M2 face one another.

FIG. 11 shows a second exemplary embodiment of the sensor arrangement according to the invention for detecting angles of rotation a on a rotated component 5 in the case of which the measured value sensor 20 is coupled to the rotated component 5 and the measured value transmitter 10 is fastened fixedly. The measured value sensor 20 comprises at least one sensor element A′ and is located on a rotational path with a radial distance R from the rotational axis 3, and moves in the event of a rotation relative to the measured value transmitter 10 on a circular track. As already set forth above, the measured value transmitter 10 comprises the multipole MP′ with two permanent magnets M1, M2 which are polarized in the direction of rotation of the measured value sensor 20 or tangential thereto, and generate a magnetic vector, in a plane perpendicular to the magnet surface, which is detected by the sensor element A upon passing by. In a way similar to FIG. 10, the two permanent magnets M1, M2 are arranged such that the mutually facing ends of the permanent magnets M1, M2 have the same magnetic polarization. In the exemplary embodiment illustrated, the magnetic south poles S of the two adjacent permanent magnets M1, M2 face one another.

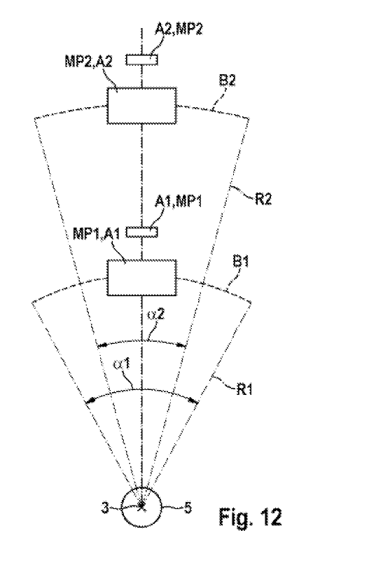

As is further evident from FIG. 12, the relationship B1=B2=constant holds between the radial distance R1, R2 of the components MP1 and A1 or MP2, A2, rotating on a circular track B1, B2 and the angular measuring range of the sensor arrangement according to the invention for detecting angles of rotation α1, α2 on a rotated component 5. This results in the equation (2).

R₁*α₁→R₂*α₂ (2)

The detected magnetic vector is related directly and in a defined fashion to the path B1, B2 on the circular track, and thus also to the angle α1, α2 of the angular segment swept over. In the exemplary embodiments illustrated, the at least one sensor element A, A′, A1, A2 of the measured value sensor 20 detects directed magnetic flux densities Bx, Bz which the evaluation circuit of the measured value sensor 20 converts into an angle of rotation α, α1, α2 for the rotated component 5. Alternatively, the at least one sensor element A can directly detect an angle of the magnetic vector, the detected angle of the magnetic vector representing the angle of rotation α, α1, α2 of the rotated component 5. By adapting the radial distance R, R1, R2 to the rotational axis 3 and/or the dimensions of the multipole MP, MP′, MP1, MP2 and/or the permanent magnets M1, M2 of the multipole MP, MP′, it is possible to tune the angular range to be measured optimally to the measuring range of the at least one sensor element A, A′, A1, A2. This holds both for the first exemplary arrangement of the sensor arrangement according to the invention for detecting angles of rotation on a rotated component from FIG. 10, and for the second exemplary arrangement of the sensor arrangement according to the invention for detecting angles of rotation on a rotated component from FIG. 11. The at least one sensor element A, A′, A1, A2 of the measured value sensor 20 is, for example, designed as an AMR sensor and/or GMR sensor and/or Hall sensor.

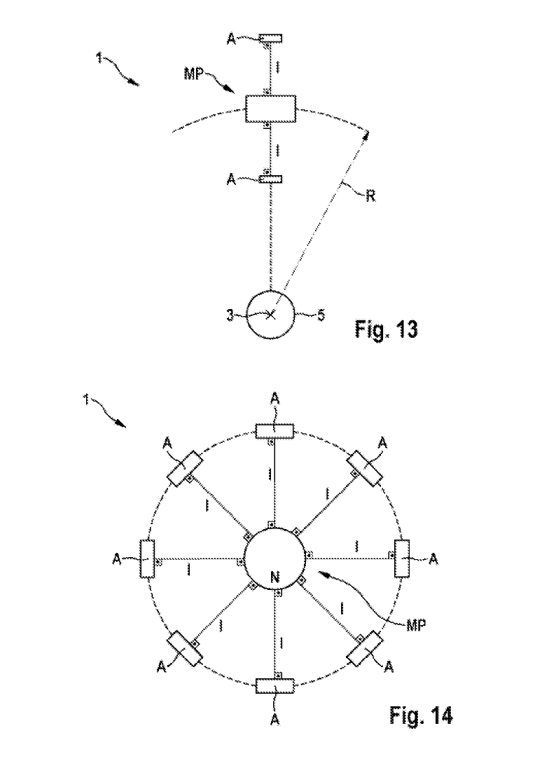

FIGS. 13 and 14 show possible relative positions of a stationary sensor element A of the measured value sensor 20 relative to a multipole MP, moving with the distance R on a circular track, of the measured value transmitter 10.

As is further evident from FIG. 13, the at least one sensor element A of the measured value sensor 20 is fixedly fastened with a prescribed radial distance 1 relative to the circular track of the multipole MP of the measured value transmitter 10. Here, the at least one sensor element A can have a radial distance of (R−l) relative to the rotational axis 3. Alternatively, the at least one sensor element A can have a radial distance of (R+l) from the rotational axis 3. As is further evident from FIG. 14, the at least one sensor element A can occupy various positions on a circumcircle of radius 1 around the multipole MP of the measured value transmitter 10. The position of the at least one sensor element A relative to the multipole MP is selected in such a way that the magnetic vector which lies in the plane perpendicular to the multipole MP is always detected, the permanent magnets M1, M2 of the multipole MP being magnetized and/or polarized in a circumferential direction.

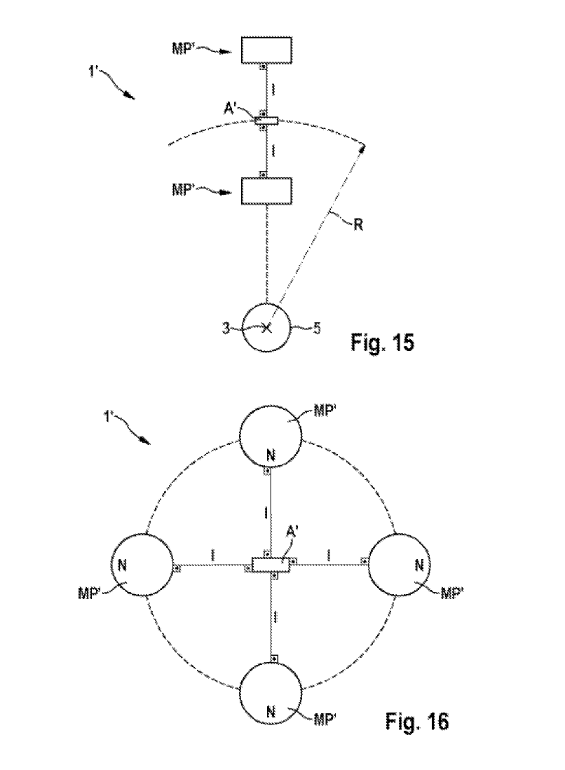

FIGS. 15 and 16 show possible relative positions of a stationary measured value transmitter 10 with a multipole MP′ relative to a measured value sensor, moving with the distance R on a circular track, with at least one sensor element A′.

As is further evident from FIG. 15, the multipole MP′ of the measured value transmitter 10 is fixedly fastened with a prescribed radial distance 1 to the circular track of the at least one sensor element A′ of the measured value sensor 20. Here, the multipole MP′ of the measured value transmitter 10 can have a radial distance of (R−l) relative to the rotational axis 3.

Alternatively, the multipole MP′ of the measured value transmitter 10 can have a radial distance of (R+l) relative to the rotational axis 3. As is further evident from FIG. 16, the multipole MP′ of the measured value transmitter 10 can occupy various positions on a circumcircle of radius 1 about the at least one sensor element A′ of the measured value sensor 20. The position of the multipole MP′ relative to the at least one sensor element A′ is selected in such a way that the magnetic vector which lies in the plane perpendicular to the multipole MP′ is always detected, the permanent magnets M1, M2 of the multipole MP′ of the at least one sensor element A′ being magnetized and/or polarized in the circumferential direction of the circular movement.

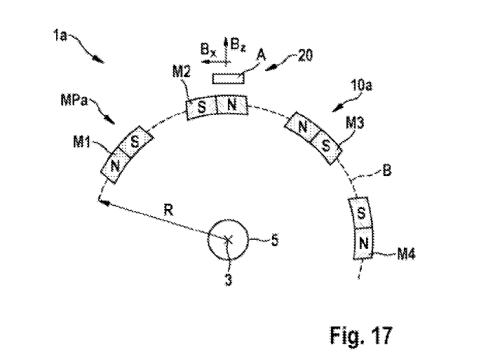

FIG. 17 shows a third exemplary arrangement of the sensor arrangement 1a according to the invention for detecting angles of rotation on a rotated component 5, in the case of which the measured value transmitter 10a is coupled to the rotated component 5 and the measured value sensor 20, which comprises at least one sensor element A, is fixedly fastened. In the exemplary embodiment illustrated, the measured value transmitter 10a comprises a multipole MPa with four permanent magnets M1, M2, M3, M4, which are located with a radial distance R from the rotational axis 3 on a rotational path and which move on a circular track upon rotation relative to the magnetically-sensitive sensor element A of the measured value sensor 20. The permanent magnets M1, M2, M3, M4 are polarized in the circumferential direction or tangential relative thereto and generate a magnetic vector in a plane, perpendicular to the magnet surface, which is detected by the sensor element A upon passing by, the four permanent magnets M1, M2, M3, M4 being arranged such that the mutually facing ends of the permanent magnets M1, M2, M3, M4 have the same magnetic polarization. In the exemplary embodiment illustrated, the magnetic south poles S of the adjacent first and second permanent magnets M1, M2 and of the adjacent third and fourth permanent magnets M3, M4 face one another. In the case of the adjacent second and third permanent magnets M2, M3, the magnetic north poles N face one another. Given the arrangement according to the invention, the use of a multipole with four permanent magnets and eight magnetic poles results in a repetition of the measuring signals within the measuring range such that the measuring signals alone do not supply an unambiguous measurement result, and so additional measures are adopted in the evaluation in order to resolve the ambiguity.

Of course, the number of the permanent magnets or the number of the magnetic poles of the multipole used is not restricted to two or four permanent magnets with four or eight magnetic poles, and so it is also possible to use another number of permanent magnets or magnetic poles.

In one exemplary embodiment (not illustrated) of the sensor arrangement according to the invention, the at least two permanent magnets of the at least one multipole of the measured value transmitter are combined by way of example to form a tripole with three magnetic poles which has identical magnetic poles at its ends. Such a tripole is, for example, a north pole/south pole/north pole or a south pole/north pole/south pole sequence of the magnetic poles.

In order to adapt to an installation space and a measured angle range, it is possible for the prescribed first and/or second radial distance R, R1, R2, R−l, R+l of the measured value transmitter 10, 10a and/or of the measured value sensor 20 from the rotational axis 3 of the rotated component 5, and/or the prescribed radial distance 1 between the measured value transmitter 10, 10a and the measured value sensor 20, and/or the dimensions of the at least one multipole MP, MPa, MP′, MP1, MP2, and/or the number of the multipoles MP, MPa, MP′, MP1, MP2, and/or the dimensions of the at least one permanent magnet M1, M2, M3, M4, and/or the number of the permanent magnets M1, M2, M3, M4 of the at least one multipole MP, MPa, MP′, MP1, MP2, and/or the dimensions of the at least one sensor element A, A′, A1, A2, and/or the number of the sensor elements A, A′, A1, A2 of the measured value sensor 20 to be appropriately selected and designed. Furthermore, the arrangement of the measured value transmitter 10, 10a and/or of the measured value sensor 20 are adapted to the installation space and the measured angle range such that a maximum change in the angle of the magnetic vector results over the measured angle range.

As an alternative to determining a pedal position, it is also possible for embodiments of the sensor arrangement according to the invention to be used to determine an angle of rotation of a steering column or other rotatable components present in the vehicle.

1. A sensor arrangement for detecting an angle of rotation of a rotated component, comprising:
a measured value transmitter having at least one permanent magnet having a magnetic north pole region and a magnetic south pole region, the at least one permanent magnet being arranged at a first prescribed radial distance from a rotational axis of the rotated component, and being polarized along a circular arc with the first prescribed radial distance about the rotational axis to generate a magnetic vector in a detection plane perpendicular to a surface of the at least one permanent magnet; and
a measured value sensor configured to detect at least one magnetic variable, the measured value sensor having at least one sensor element arranged at a second prescribed radial distance from the rotational axis of the rotated component, a movement of the rotated component causing a variation in the at least one magnetic variable that is evaluated to determine the angle of rotation of the rotated component, the measured value transmitter having at least one multipole having at least two permanent magnets that are arranged such that the mutually facing ends of directly adjacent permanent magnets of the at least two permanent magnets of the multipole have a same magnetic polarization.

2. The sensor arrangement as claimed in claim 1, wherein the at least one sensor element of the measured value sensor is configured to detect an angle of the magnetic vector, the angle of the magnetic vector representing the angle of rotation of the rotated component.

3. The sensor arrangement as claimed in claim 1, wherein the at least one sensor element is configured to detect directed magnetic flux densities and convert the directed magnetic flux densities into the angle of rotation for the rotated component.

4. The sensor arrangement as claimed in claim 1, wherein:
the measured value transmitter is coupled to the rotated component; and
the measured value sensor is fastened at a prescribed radial distance from a circular track of the measured value transmitter.

5. The sensor arrangement as claimed in claim 1, wherein:
the measured value sensor is coupled to the rotated component; and
the measured value transmitter is fastened at a prescribed radial distance from a circular track of the measured value sensor.

6. The sensor arrangement as claimed in claim 1, wherein at least one of (i) the first prescribed radial distance from the rotational axis of the rotated component, (ii) the second prescribed radial distance from the rotational axis of the rotated component, (iii) a prescribed radial distance between the measured value transmitter and the measured value sensor, (iv) dimensions of the at least one multipole of the measured value sensor, (v) a number of the multipoles of the at least one multipole of the measured value sensor, (vi) dimensions of the at least one permanent magnet of the measured value transmitter, (vii) a number of the permanent magnets of the at least two permanent magnets of the at least one multipole of the measured value sensor, (viii) dimensions of the at least one sensor element of the measured value sensor, and (ix) a number of the sensor elements of the at least one sensor element of the measured value sensor are adapted to an installation space and a measured angle range.

7. The sensor arrangement as claimed in claim 6, wherein an arrangement of at least one of the measured value transmitter and the measured value sensor is adapted to the installation space and the measured angle range such that a maximum change in an angle of the magnetic vector occurs over the measured angle range.

8. The sensor arrangement as claimed in claim 1, wherein the at least one sensor element of the measured value sensor is at least one of an anisotropic magnetoresistance sensor, a giant magnetoresistance sensor, and a Hall sensor.

9. The sensor arrangement as claimed in claim 1, wherein the at least two permanent magnets of the at least one multipole of the measured value transmitter are at least one of (i) bar magnets having at least one of a round and rectangular cross section and (ii) bar magnets having at least one of a round and rectangular cross section and at least one of a single-ended rounded portion and a double-ended rounded portion.

10. The sensor arrangement as claimed in claim 9, wherein the rounded portion has a curvature that corresponds to a prescribed circular arc of a the rotational path of at least one of the measured value transmitter and the measured value sensor.

11. The sensor arrangement as claimed in claim 1, wherein the at least one multipole of the measured value transmitter is a tripole having three magnetic poles and identical magnetic poles at each end of the tripole.

12. The sensor arrangement as claimed in claim 1, wherein the rotating component is at least one of a pedal and a steering column.
